(19) United States
(12) Patent Application Publication
(10) Pub. No.: US 2022/0237688 A1
(43) Pub. Date: Jul. 28, 2022

(54) METHOD AND SYSTEM FOR AUTOMATED ORDER FULFILLMENT

(71) Applicant: 370 Legacy, Inc., Las Vegas, NV (US)

(72) Inventor: Awah Ngu TEH, Los Angeles, CA (US)

(21) Appl. No.: 17/585,362

(22) Filed: Jan. 26, 2022

Related U.S. Application Data
(60) Provisional application No. 63/141,659, filed on Jan. 26, 2021.

(51) Int. Cl. G06Q 30/06; G06Q 10/08

(52) U.S. Cl. CPC G06Q 30/0637; G06Q 10/087

(57) ABSTRACT

Methods and systems for to provide an automated trading platform to provide high trading liquidity to end users. In some embodiments, the platform can expand the market for rare collectibles by providing partial ownership and an automated market participant to help increase liquidity.

### CROSS-REFERENCE TO RELATED APPLICATIONS

This application claims priority to U.S. Provisional Patent Application Ser. No. 63/141,659, filed on Jan. 26, 2021, the contents of which is incorporated herein by reference in its entirety and for all purposes.

### FIELD

The disclosed embodiments relate generally to automating order fulfillment and more particularly, but not exclusively, to a method and system for automating the fulfillment of any given market order.

### BACKGROUND

As is known in the art, the value of each stock is driven by economic theory factors such as supply, demand, and other value determinants made by investors. Those factors are integrated by the market and the price of any given stock is set to the last price of a trade on the platform further bound by the current bid and ask.

In order for any trading order in a market platform to be fulfilled (be it purchase or sale orders), there must be enough other traders on the platform that are willing to buy/sell at the bid/asking price. In a highly liquid market and on a stock that has a lot of demand/supply, this liquidity is usually easily achieved.

However, if there are few market participants/activity or the bid-ask-spread is too wide, liquidity can be hard to come by, which could lead to general investor frustration with the trading platform—rather than the asset itself. This can be a particular problem for markets involving rare items and low volume goods.

For example, collectables, being unique items, are inherently scarce. Despite securitization expanding the market for these goods, the market for these shares may experience low trade volume. Low volume markets have inherent problems for market participants, such as lack of liquidity and unpredictable pricing. Lack of liquidity means that a buyer or seller might not be able to complete a transaction because there is no counterparty to match the transaction. And low volume tends to create large bid/ask spreads which leads to unpredictable pricing. Existing collectables markets try to solve this problem by limiting the amount of time the market is open. The hope is that if the market is only open for a few hours one day a week, increased participation can be maintained during that small window. This, however, does not really solve the liquidity issue as market participants cannot buy and sell shares except in these limited windows. And the bid/ask spread issue is only improved if the right buyers and sellers participate during the limited market opening.

In view of the foregoing, there is a need for an improved system and method for an automated trading platform that overcome the drawbacks of existing solutions.

### BRIEF DESCRIPTION OF THE DRAWINGS

FIG. 1 is a top-level diagram illustrating one exemplary embodiment of an automated trading platform.

FIG. 2 is a diagram illustrating another exemplary embodiment of the automated trading platform of FIG. 1.

FIG. 3 is a top-level diagram illustrating one embodiment of the trading engine of the automated trading platform of FIG. 2.

FIG. 4 is a diagram illustrating another embodiment of the trading engine of FIG. 3.

FIG. 5 is a flow-diagram illustrating one exemplary embodiment of a method for using the automated trading platform of FIG. 1.

FIG. 6 is a flow-diagram illustrating one exemplary embodiment of a method for automating order fulfillment using the automated trading platform of FIG. 1.

FIG. 7 is a functional block diagram illustrating one exemplary embodiment of the data flow using the automated trading platform of FIG. 1.

FIG. 8 is a diagram illustrating an exemplary embodiment of a software architecture for implementing the automated trading platform of FIG. 1.

FIG. 9 is a diagram illustrating an exemplary embodiment of a machine for implementing the automated trading platform of FIG. 1.

FIG. 10 is a diagram illustrating an embodiment of an exemplary user interface of the automated trading platform of FIG. 1.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Because currently available systems and methods for online trading are incapable of accommodating the lack of liquidity and unpredictable pricing of low volume markets, an improved system and method for automated order fulfillment can overcome the drawbacks as set forth above, can prove desirable, and can provide a basis for a wide range of applications, such as e-commerce management, securitization, and the like.

System Architecture

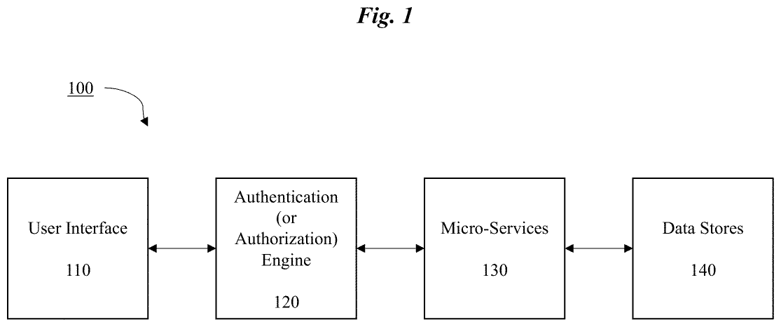

FIG. 1 is a schematic diagram of an automated trading platform 100. As shown, the automated trading platform can be distributed into four functional blocks: a user interface 110, an authentication (or authorization) engine 120, and one or more micro-services 130 in operable communication with at least one data store 140.

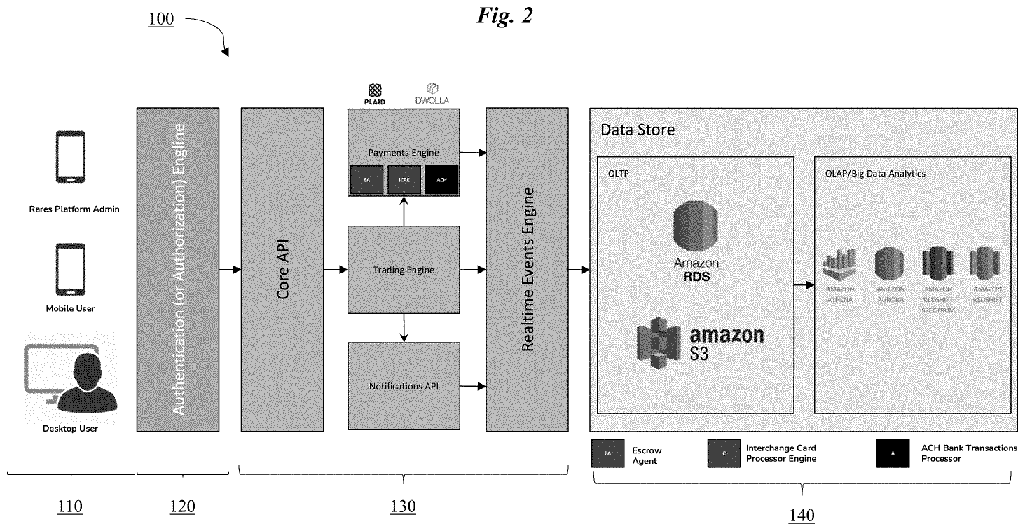

In some embodiments, the architecture of the automated trading platform 100 can include several independent, but interrelated, components that are designed to function as a standalone component and can communicate with each other. For example, turning to FIG. 2, exemplary architecture components of the automated trading platform 100 is shown in further detail.

User Interface 110

Exemplary user interfaces of the automated trading platform 100 include, but are not limited to:

Mobile Device: mobile devices used to access the automated trading platform 100 from a mobile application downloaded from either the Apple Store or the Google Play Store.

Desktop Computer: this is a desktop computing device (including laptops) from which users can leverage their web browsers to access the automated trading platform 100.

Admin Console: This is a set of SDK (Software Development Kit), CLI (Command Line Interface), and web browser-based user interfaces from which authorized administrators are able to access the platform data and moderate community content.

Authentication (or Authorization) Engine 120

The automated trading platform 100 authenticates and authorizes access to the underlying platform data for end users as well as authorized Administrator personnel via the authentication (or authorization) engine 120. The authentication (or authorization) engine uses a variety of techniques including intrusion detection controls, as well as offering two-factor authentication capabilities to end users so as to further secure their automated trading platform 100 account. Lastly, to limit the storing of user credentials (even in encrypted form), the platform offers its end users the ability to authenticate using social logins (e.g., login with Facebook, Login with Google, and Login with Twitter).

Micro-Services 130

These are a suite of micro-services 130 that govern the proper functioning of the automated trading platform 100, and include the following set of micro-services:

Core API: Core set of functionalities for the automated trading platform 100.

Payments Engine: The engine that manages payments on the automated trading platform 100. The payments engine can be further broken down into at least three subsegments:

Escrow Agent (Payment Engine subsegment): This portion of the payments engine is responsible for managing any funds withheld pending the completion of a given trade by the trading engine. It is important to note that the escrow agent is capable of requesting and withholding variable amounts of trader funds, particularly in the case of market orders where the price of the traded asset can vary up to 10% from the prices of the asset when the original market order was created. The sophistication of managing the escrow balances for each and every transaction processed by the automated trading platform 100 is built into the escrow agent subsegment. Portions of the escrow agent use underlying balance account technology supplied by Dwolla.

Interchange Card Processing Engine (Payment Engine subsegment): This subcomponent is responsible for processing debit card and credit card transactions related to the purchasing of assets on the automated trading platform 100.

ACH Bank Transactions Processor (Payment Engine subsegment): This subcomponent is responsible for processing ACH bank transfers (as well as wire transfers where applicable) related to the purchase or sale of assets on the automated trading platform 100.

Trading Engine: The engine including the Platform Market Mover (PMM) engine described herein that governs all trading activities that happen on the automated trading platform 100.

Notifications API: This key micro-service is responsible for ensuring timely notification of important events related to a given customer's account or assets on the platform (e.g., price changes of assets, successful completion of trade, etc.).

Realtime Events Engine: This micro-service is responsible for intercommunication between each of the micro-services in a near real time fashion. Each of the micro-services react to events that occur anywhere in the overall infrastructure via the realtime events engine (e.g., communicating price changes in a given asset to the user interface without the need of the end user having to do anything like (refresh their browser) to acquire this new market insight).

Data Stores 140

This component of the overall platform architecture is responsible for the secure storage of data related to the platform including data about end users, trading transactions and social interaction on the platform. Data within the platform can be broadly categorized into two main areas:

Online Transaction Processing Data (OLTP): captures, stores, and processes data from transactions in real time.

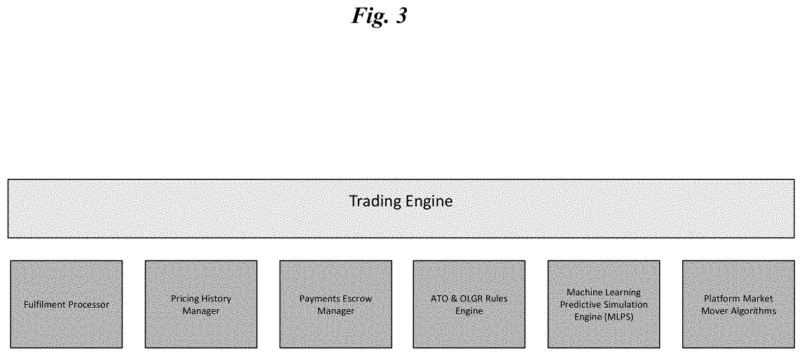

Online Analytical Processing Data (OLAP): uses complex queries to analyze aggregated historical data from OLTP transactions. This is where the data lake of FIG. 3 is housed and where big data analytics are conducted to drive market insights in how the platform can be better utilized and the customers' user experience can be improved.

Trading Engine Components

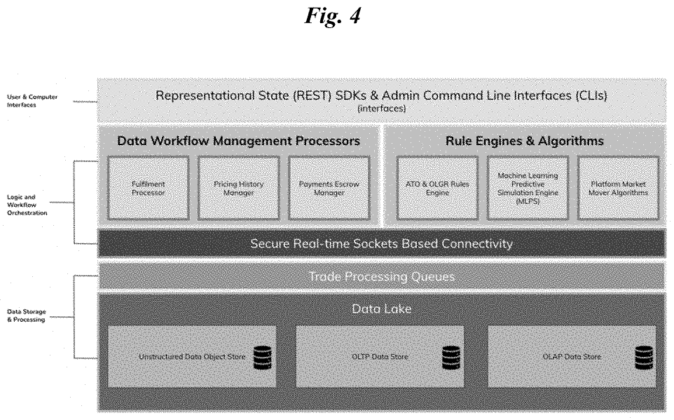

Turning to FIG. 3, an exemplary block diagram illustrating additional components of the trading engine shown in FIG. 2 is shown. FIG. 4 illustrates the functional data flow between the components shown in FIG. 3. The additional components of the trading engine include:

Fulfilment Processor (FP): The fulfilment processor is designed to compute effective inventory and compute the trades needed to fulfil any trading transaction order that is sent to the trading engine. It achieves this by effective inventory tracking, user-configured trading order limit guard rails (guard rails or OLGRs), updating prices in real-time, and executing trades atomically.

The FP conducts effective inventory tracking, meaning that the FP takes into consideration the inventory of stock that end users have chosen to trade, while also computing those trades that are currently in-flight (being processed) by other trading transactions, and in other instances of the trading engine.

With respect to user-configured trading guard rails, the FP is constantly listening to real-time signals from the market and the PMM to ensure that no trade it executes violates any user configured trading guard rail safeties, which are upper and lower limits on trading.

The FP updates prices in real-time, meaning that the FP sends out signals to the other micro-services of the platform about any price changes to a given stock that result from the execution of a given trade.

Once all trades have been computed, the FP executes each trade atomically, meaning that each trade that is executed by the platform stands alone and can be rolled back individually without affecting the overall transaction. A transaction might be a collection of several trades between market participants and the PMM. Whenever a trade is executed by the FP, any associated escrowed funds are released into the account of the seller, and, if need be (e.g., there is a price increase on the stock), additional funds are held in escrow from the buyer's trading account wallet.

Pricing History Manager (Ticker): This component is responsible for tracking and reporting on price changes to a given stock symbol and generating the necessary data to visualize stock price changes overtime in a ticker chart.

Payments Escrow Manager: This component is responsible for capturing and releasing escrow funds required to fulfil a given trading transaction. As every trade is executed, escrowed funds are released from the escrow holding account into the seller's account (as applicable). If the order type associated with the transaction is a market order and there is a price change (increase/decrease) on the stock, the originally held escrow amount may no longer be appropriate for the completion of the trade. The payments escrow manager automatically reconciles this difference and attempts to adjust the escrow amount to fit the needs of the trading transaction.

Automated Transaction Order (ATO) & Order Limit Guard Rail (OLGR) Rules Engine: This is the rules engine that enforces the logic needed to execute automated transaction orders (ATOS) and OLGRs in an automated, yet human configurable fashion. This engine takes advantage of tuple and node fact pattern processing (e.g., the Rete Algorithm) to perform massive amounts of computational inferences in a radically short amount of time thereby enabling almost real-time decision support for the trading engine and faster trade execution times.

Machine Learning Predictive Simulation Engine (MLPS): The MLPS is a component of the trading engine that takes advantage of the Rete Algorithm to predict points within a given trading transaction wherein the PMM may need to step in. Using the predictive model generated by the MLPS, the PMM can optimize how much of, and where in the trading lifecycle the PMM allocation gets distributed. This engine is advantageous to the optimal functioning of the PMM as it helps to optimize market liquidity by preventing the PMM from exhausting its share allocation too early in the trading life cycle.

This can be better illustrated by referencing the example in the First Embodiment described herein. The MLPS played a big role in the First Embodiment by consuming input from the ATO & OLGR Rules engine and using said input to predict that the PMM would not be able to play a role in closing the gap between Danielle and Adam, as the 30% price jump far exceeded the 10% OLGR configuration in place for that order.

Because of this, the MLPS greenlit the PMM to consume the entirety of its PMM allocation on all PMM interventions prior to the gap between Danielle and Adam. The PMM did so in actions #5 and #6 in the actions log table outlined in the Example Scenario described below, which helped close the price gap between Cathy (Market Price) and Danielle ($10.75 per share).

Now if we changed some parameters in the exact same scenario, as in the Second Embodiment, and move the configured OLGR from 10% to 40%, the MLPS would now make a different prediction, since it can now predictively compute a likelihood that the PMM can play a role in closing the gaps not only between Cathy and Danielle, but also between Danielle and Edgar, as the 30% price jump is now well within the 40% configured OLGR limit. Under such a scenario, it wouldn't make sense then for the PMM to spend its entirety of the PMM allocation on closing the gap between Cathy and Danielle, but rather spread that allocation between Cathy & Danielle, as well as Danielle and Edgar.

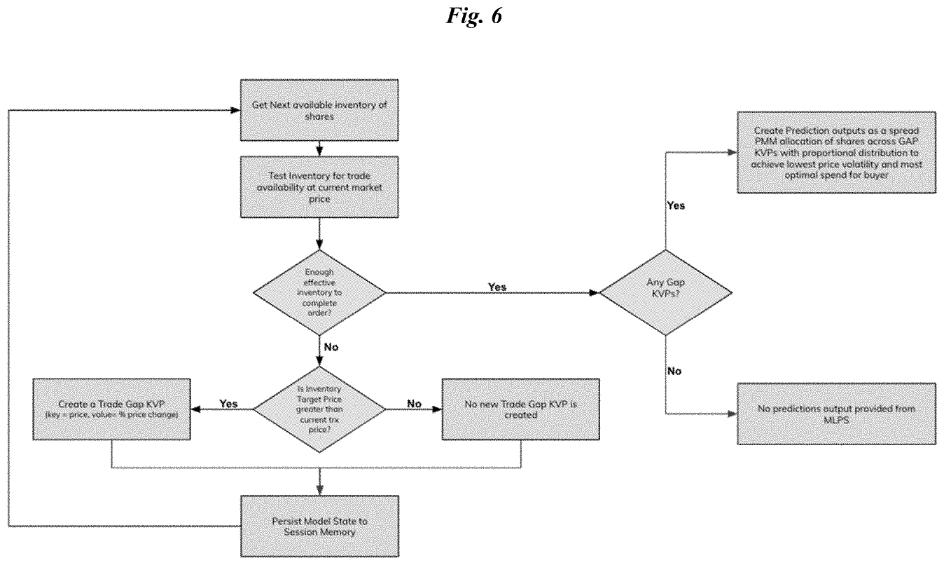

The net effect of doing so, is twofold. First, increased liquidity in trades for the fulfilment of that transaction results from the broader PMM allocation. Second, the buyer gets better overall average pricing given that the PMM is designed to close gaps in price by offering the sell/buy shares to the trader at the best market price for as many shares as it possibly can. If the PMM exhausted its allocation on the lower priced shares and had no more allocation left when it came to higher priced shares, then the end-user might not get the best prices possible, but due to the intelligence brought about by the MLPS working in concert with other components of the trading engine, the best possible prices are computed and executed upon for the trader. This data flow is shown in FIG. 6.

Platform Market Mover (PMM): The PMM leverages input from the end-user and the other components of the Trading Engine to maximize trading liquidity and minimize wild pricing fluctuations by helping to smooth over the gaps between stock prices bid-ask-spreads. It accomplishes this by dynamically and intelligently stepping into trading transactions for which there are large gaps in inventory or bid-ask pricing and fulfilling portions of the order to facilitate the completion of the transaction and ensuring market liquidity around the clock. By design, the PMM shouldn't step in frequently in a highly liquid market; rather, it would let market participants trade as much as possible with each other and only step in to close ask-bid spreads.

The PMM is an automated market participant added to the market platform structure to help increase liquidity in the market. To help mitigate trade frustration and improve trading experience for all traders on the platform, the PMM acts as an automated “middle-man” to execute on the buy/sell side of active trades in order to help fill in the bid-ask-spread. For example, in absence of matching Stop or Limit orders the PMM can step in and automate the fulfilment of any given market order.

Each individual asset in the platform's inventory can have a unique designation, such as a stock symbol up to 16 characters long. The stock symbol, along with the asset's name, can be used to quickly find the asset on the automated trading platform 100 and view its trading performance. By using unique asset symbols, the system can account for duplicate items. For example, if the platform acquired and currently has in inventory two pairs of 1995 Nike Air Max, each pair of shoes can be initially publicly offered on a stock exchange as its own individual asset and as such get its own symbol, or each pair of shoes can be combined together in one asset and both will be considered one asset and hence have one symbol. In the former example, the symbol for the first pair of shoes could be NIKEAFONE95-1, and the second one's symbol would be NIKEAFONE95-2.

For market participants, bids and ask prices on the platform can employ stop and limit orders or similar instruments, collectively referred to in this document as ATOs. Trading on the platform may be governed by the following basic rules: Market price buy orders are fulfilled from best-to-worst price to the buyer depending on demand. All market price buy orders are pending until fulfilled by a seller that has an active ask that matches with the bid associated with the buy order, or associated ATOs necessary to fulfil the market price buy order are triggered.

Order volume might impact the total price the order sells or buys for. Due to volatility in price, a “market” buy order to purchase 100 shares might end up costing more than the current market price times 100 because of low volume. For example, if the current market price of NIKEAFONE95-1 is $20.01 per share at the time of an order, a purchase of 100 shares may end up costing more than $2001. If there is not a matching sell order (or combination of sell orders) offering 100 shares of the stock for $20.01 then the rest of the order would need to be fulfilled at the next sell order price, which would be above $20.01.

Fill or kill transactions are only executed against the current market price, and do not offer bid/ask capability to the trader. Fill or kill transactions require the market to fulfill the entire order immediately at the market price or not at all. These types of instant liquidity transactions are subject to market availability.

Price per share for each initial public offering on a stock exchange (IPO) does not change until the IPO closes and the shares are available for trading on a secondary market basis.

Order Fulfillment Process (OFP)

In order to understand how the PMM works, it first helps to understand how market orders are fulfilled on the platform. A market order is placed in a pending state until an intersecting ask/bid can be found to trigger the start of the order fulfilment process. Once started, the platform will continue buying shares at the best possible prices by continuously “buying-out” any active ATOs on the platform, including any active market orders in the system. This process continues until the order is completely fulfilled or there aren't any outstanding shares left to trade on the particular asset.

The PMM is designed to help fill in the gap between the market price of an asset and the next best intersecting ask/bid to help trigger cycles of the OFP.

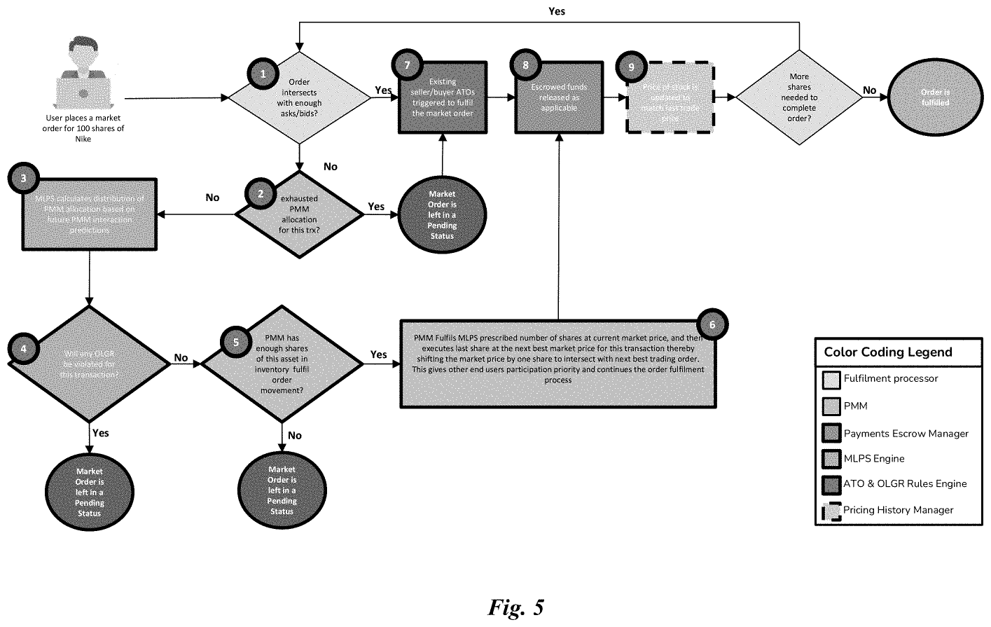

By way of example, turning to FIG. 5, assume a rare commodity (e.g., Nike Air Force Ones 95) is trading at a market price of $20.01 per share, and Jim wants to buy 100 shares. Jenny and Jacky both have Automated Transaction Orders to sell their shares if the price hits $21 and $22.50 respectively. In such a market, there is no liquidity because the ask/bid prices don't intersect the market prices. As shown in FIG. 5, to help close that gap, the PMM will:

1. Fill 10% of the overall market order of Jim by selling him 10 shares at the market price from the PMM's inventory based on availability. Thereby triggering the order fulfillment process.

2. The PMM will then adjust its ask/bid price to now be higher than the highest ask price in the market and lower than the lowest bid price in the market. This is done in order to have the OFP continue the fulfillment of the pending market orders with assets owned by end users rather than the platform.

3. MLPS Predictions: Between step 1 and 2 above, the MLPS will run a series of predictions to help the PMM decide:

a) How many price gaps could possibly exist while trying to fulfill the order.

b) Using information from step (a) above, decide when the PMM should jump in.

c) Finally, each time the PMM intervenes, how many shares the PMM should participate with to achieve its objective effectively across all possible gaps in prices, given the total allocation of shares that the PMM is allowed to participate in that order.

### Example Scenario: First Embodiment

One embodiment of the present system is exemplified in the following two tables. The state of the market between four participants, Adam, Barry, Cathy, and Danielle, is outlined in the following table. In the table after the following table, what happens when a fifth participant, Edgar, comes into play and places a market order for 100 shares at the current market price indicated below is outlined.

Current State of the Market: (Market price of AJ1985CHI is $10/Share)

| Participant | Inventory | Transactions/Orders |
|---|---|---|
| Adam | 100 Shares of stock Symbol: | SELL 90 shares @ |
| | AJ1985CHI | $14/share |
| Barry | 20 Shares of stock Symbol: | SELL 5 shares @ |
| | AJ1985CHI | Market Price |
| Cathy | 30 Shares of stock Symbol: | SELL 3 Shares @ |
| | AJ1985CHI | Market Price |
| Danielle | 10 Shares of stock Symbol: | SELL 3 shares @ |
| | AJ1985CHI | $10.75 per share |
| PMM | 100 Shares of stock Symbol: | N/A |
| | AJ1985CHI | |

Scenario A: Edgar (a new market participant in the AJ1985CHI Stock Symbol), decides to buy 100 shares of AJ1985CHI at market price with the default guard rails set at 10% of the market price at time of purchase. At the time of purchase, the price per share for AJ1985CHI is $10/share.

The following trading engine log table, is an output of the decisions made by the trading engine to execute and fulfil Edgar's order given available inventory and configured guard rail constraints.

This scenario is designed out to showcase three unique mechanics of the PMM:

1. Price Gap Closures: The PMM's ability to close the gap between the market price and the ask/bid prices of the market participants.

2. MLPS Optimization: Its Machine Learning Predictive Simulation is designed to optimize the participation of the PMM in any trading transaction, so as to maximize the closing of price gaps in ask-bid spreads and increase liquidity in the marketplace in general. In particular, liquidity is increased for the current trade the PMM is acting on.

3. Guard Rail Safeties: Finally, PMM has the ability to prevent runaway pricing of stock prices due to broad ask/bid spreads.

| A | Adam's Effective Inventory of the AJ1985CHI stock after the trading engine executed an | | | | | | | |
|---|---|---|---|---|---|---|---|---|
| | action. | | | | | | | |
| B | Barry's Effective Inventory of the AJ1985CHI stock after the trading engine executed an | | | | | | | |
| | action. | | | | | | | |
| C | Cathy's Effective Inventory of the AJ1985CHI stock after the trading engine executed an | | | | | | | |
| | action. | | | | | | | |
| D | Danielle's Effective Inventory of the AJ1985CHI stock after the trading engine executed | | | | | | | |
| | an action. | | | | | | | |
| E | Edgar's Effective Inventory of the AJ1985CHI stock after the trading engine executed an | | | | | | | |
| | action. | | | | | | | |
| P | The Effective Inventory of the PMM for the AJ1985CHI stock after the trading engine | | | | | | | |
| | executed an action. | | | | | | | |
| | Any row highlighted in this shade of blue is one wherein the PMM is executing a trade on | | | | | | | |
| | behalf of a transaction | | | | | | | |
| | Any row highlighted in this shade of orange, is one wherein the PMM refused to | | | | | | | |
| | participate in a trade on behalf of a transaction for one or several reasons, including | | | | | | | |
| | Guard Rail Thresholds being met, or the PMM allocation being exhausted. | | | | | | | |
| | Any cell highlighted in this shade of green is one wherein the Trading Engine executed a | | | | | | | |
| | trade which had a net effect of changing the market participant's overall inventory for the | | | | | | | |
| | AJ1985CHI stock symbol. | | | | | | | |
| | Action Taken by | Market Participants Inventory (Post Engine Action) | | | | | | New |
| | Trading Engine | A | B | C | D | E | P | Market |
| # | & PMM | (sell) | (sell) | (sell) | (sell) | (buy) | sell/buy | Price |
| 1 | Trading Engine | 90 | 5 | 3 | 3 | 0 | 100 | $10.00 per |
| | initializes the | ($14/ | (Market | (Market | ($10.75/ | | | share |
| | transaction placed by | share) | Price) | Price) | share) | | | |
| | Danielle, and gets an | | | | | | | |
| | assessment of all | | | | | | | |
| | available effective | | | | | | | |
| | inventory to transact | | | | | | | |
| | with | | | | | | | |
| 2 | Trading engine | 90 | 5 | 0 | 3 | 3 | 100 | $10.00 per |
| | Acquires all | | | | | | | share |
| | 3 effective available | | | | | | | |
| | shares from Cathy to | | | | | | | |
| | help fulfil Edgar's | | | | | | | |
| | order | | | | | | | |
| 3 | Trading engine | 90 | 0 | 0 | 3 | 8 | 100 | $10.00 per |
| | Acquires all | | | | | | | share |
| | 5 effective available | | | | | | | |
| | shares from Barry to | | | | | | | |
| | help fulfil Edgar's | | | | | | | |
| | order | | | | | | | |
| 4 | Trading engine discovers a gap between the market price of $10/share and Danielle's Ask price | | | | | | | |
| | of $10.75/share (a 7.5% increase in the price which is well within the 10% configured guard rail | | | | | | | |
| | limit of 10% delta). As such the PMM kicks in and while taking into account machine learning | | | | | | | |
| | predictive simulation of future gaps in price associated with this trade, allocates the entire 10% | | | | | | | |
| | (PMM allowance) of shares requested in the original order for which ALL but one share is to be | | | | | | | |
| | sold to Edgar at the current Market Price, and the last share to be sold at the next best Ask price | | | | | | | |
| | in the market | | | | | | | |
| 5 | Sell all but one share | 90 | 0 | 0 | 3 | 17 | 91 | $10.00 per |
| | of the 10% allocated | | | | | | | share |
| | by the PMM to Edgar | | | | | | | |
| | (a total of 9 shares) at | | | | | | | |
| | market price | | | | | | | |
| 6 | Sell the last share of | 90 | 0 | 0 | 3 | 18 | 90 | $10.75 per |
| | the PMM allocated lot | | | | | | | share |
| | to Edgar at the next | | | | | | | |
| | best ask price in the | | | | | | | |
| | market (which is | | | | | | | |
| | Danielle's price | | | | | | | |
| | @10.75 per share) | | | | | | | |
| 7 | Given that the current | 90 | 0 | 0 | 0 | 21 | 90 | $10.75 per |
| | Market price closely | | | | | | | share |
| | matches an existing | | | | | | | |
| | Aks price in the | | | | | | | |
| | market (Danielle's), | | | | | | | |
| | the trading engine can | | | | | | | |
| | now proceed to sell | | | | | | | |
| | Danielle's shares at | | | | | | | |
| | her desired ask price to | | | | | | | |
| | Edgar | | | | | | | |
| 8 | Again as was with Action #4 above, the trade engine discovers yet another gap between the | | | | | | | |
| | current market price of ($10.75 per share) and Adam's ask price of $14/share (a 30% increase in | | | | | | | |
| | the price which now exceeds the configured guard rail limit of 10% delta). | | | | | | | |
| | As such the PMM will not kick in, and the trading engine will stop here on this transaction (until | | | | | | | |
| | other market dynamics make this trade relevant again, e.g. more inventory becomes available | | | | | | | |
| | closer to the $10.75 per share price point). | | | | | | | |
| | The two main reasons the PMM will no longer engage in this particular transaction are: | | | | | | | |
| | Configured Guard Rails for this transaction have been breached, and so they will | | | | | | | |
| | automatically act to prevent run away pricing of the stock | | | | | | | |
| | The PMM allowance (which is a given number of shares that a PMM can | | | | | | | |
| | engage with a given transaction [10% of the original quantities of shares | | | | | | | |
| | ordered]) has been exhausted. | | | | | | | |
| | Totals | 90 (w/ | 0 (w/ | 0 (w/ | 0 (w/ | 21 (w/ | 90 (w/ | $10.75 per |
| | | 100 total | 15 total | 27 total | 7 total | 21 total | 90 total | share |
| | | inv.) | inv.) | inv.) | inv.) | inv.) | inv.) | |

### Example Scenario: Second Embodiment

In the previous embodiment, we illustrated a flow of the MPLS wherein MLPS's predictive capabilities indicated that the PMM should sell a majority of the PMM allocation by Step 4.

This scenario illustrates an alternative embodiment of the system, wherein the MLPS only executes the buy/sell of just one share via the PMM at a price required to close any gaps within the configured guard rails limits for the transaction. The only point where the MLPS will recommend to the PMM to buy/sell more than one share is at the end when it discovers that there is no other option for the PMM to participate due to guard rail limitations.

The state of the market between four participants, Adam, Barry, Cathy, and Danielle, is outlined in the following table. In the table after the following table, what happens when a fifth participant, Edgar, comes into play and places a market order for 100 shares at the current market price indicated below is outlined.

Current State of the Market: (Market price of AJ1985CHI is $10/Share)

| Participant | Inventory | Transactions/Orders |
|---|---|---|
| Adam | 100 Shares of stock Symbol: | SELL 90 shares @ |
| | AJ1985CHI | $14/share |
| Barry | 20 Shares of stock Symbol: | SELL 5 shares @ |
| | AJ1985CHI | Market Price |
| Cathy | 30 Shares of stock Symbol: | SELL 3 Shares @ |
| | AJ1985CHI | Market Price |
| Danielle | 10 Shares of stock Symbol: | SELL 3 shares @ |
| | AJ1985CHI | $10.75 per share |
| PMM | 100 Shares of stock Symbol: | N/A |
| | AJ1985CHI | |

Scenario A: Edgar (a new market participant in the AJ1985CHI Stock Symbol), decides to buy 100 shares of AJ1985CHI at market price with the default guard rails set at 10% of the market price at time of purchase. At the time of purchase, the price per share for AJ1985CHI is $10/share.

The following trading engine log table is an output of the decisions made by the trading engine to execute and fulfil Edgar's order given available inventory and configured guard rail constraints.

| A | Adam's Effective Inventory of the AJ1985CHI stock after the trading engine executed an | | | | | | | |
|---|---|---|---|---|---|---|---|---|
| | action. | | | | | | | |
| B | Barry's Effective Inventory of the AJ1985CHI stock after the trading engine executed an | | | | | | | |
| | action. | | | | | | | |
| C | Cathy's Effective Inventory of the AJ1985CHI stock after the trading engine executed an | | | | | | | |
| | action. | | | | | | | |
| D | Danielle's Effective Inventory of the AJ1985CHI stock after the trading engine executed | | | | | | | |
| | an action. | | | | | | | |
| E | Edgar's Effective Inventory of the AJ1985CHI stock after the trading engine executed an | | | | | | | |
| | action. | | | | | | | |
| P | The Effective Inventory of the PMM for the AJ1985CHI stock after the trading engine | | | | | | | |
| | executed an action. | | | | | | | |
| | Any row highlighted in this shade of blue is one wherein the PMM is executing a trade | | | | | | | |
| | on behalf of a transaction | | | | | | | |
| | Any row highlighted in this shade of orange, is one wherein the PMM refused to | | | | | | | |
| | participate in a trade on behalf of a transaction for one or several reasons, including | | | | | | | |
| | Guard Rail Thresholds being met, or the PMM allocation being exhausted. | | | | | | | |
| | Any cell highlighted in this shade of green is one wherein the Trading Engine executed a | | | | | | | |
| | trade which had a net effect of changing the market participant's overall inventory for | | | | | | | |
| | the AJ1985CHI stock symbol. | | | | | | | |
| | Action Taken by | Market Participants Inventory (Post Engine Action) | | | | | | New |
| | Trading Engine | A | B | C | D | E | P | Market |
| # | & PMM | (sell) | (sell) | (sell) | (sell) | (buy) | sell/buy | Price |
| 1 | Trading Engine | 90 | 5 | 3 | 3 | 0 | 100 | $10.00 per |
| | initializes the | ($14/ | (Market | (Market | ($10.75/ | | | share |
| | transaction placed | share) | Price) | Price) | share) | | | |
| | by Danielle, and | | | | | | | |
| | gets an assessment | | | | | | | |
| | of all available | | | | | | | |
| | effective inventory | | | | | | | |
| | to transact with | | | | | | | |
| 2 | Trading engine | 90 | 5 | 0 | 3 | 3 | 100 | $10.00 per |
| | Acquires all | | | | | | | share |
| | 3 effective available | | | | | | | |
| | shares from Cathy | | | | | | | |
| | to help fulfil | | | | | | | |
| | Edgar's order | | | | | | | |
| 3 | Trading engine | 90 | 0 | 0 | 3 | 8 | 100 | $10.00 per |
| | Acquires all | | | | | | | share |
| | 5 effective available | | | | | | | |
| | shares from Barry | | | | | | | |
| | to help fulfil | | | | | | | |
| | Edgar's order | | | | | | | |
| 4 | Trading engine discovers a gap between the market price of $10/share and Danielle's Ask | | | | | | | |
| | price of $10.75/share (a 7.5% increase in the price which is well within the 10% | | | | | | | |
| | configured guard rail limit of 10% delta). | | | | | | | |
| 5 | Sell one share of | 90 | 0 | 0 | 3 | 9 | 99 | $10.75 per |
| | the PMM allocated | | | | | | | share |
| | lot to Edgar at the | | | | | | | |
| | next best ask price | | | | | | | |
| | in the market | | | | | | | |
| | (which is Danielle's | | | | | | | |
| | price @10.75 per | | | | | | | |
| | share) | | | | | | | |
| 6 | Given that the | 90 | 0 | 0 | 0 | 12 | 99 | $10.75 per |
| | current Market | | | | | | | share |
| | price closely | | | | | | | |
| | matches an existing | | | | | | | |
| | Aks price in the | | | | | | | |
| | market (Danielle's), | | | | | | | |
| | the trading engine | | | | | | | |
| | can now proceed to | | | | | | | |
| | sell Danielle's | | | | | | | |
| | shares at her desired | | | | | | | |
| | ask price to Edgar | | | | | | | |
| 7 | Again as was with Action #4 above, the trade engine discovers yet another gap between | | | | | | | |
| | the current market price of ($10.75 per share) and Adam's ask price of $14/share (a | | | | | | | |
| | 30% increase in the price which now exceeds the configured guard rail limit of 10% delta). | | | | | | | |
| | As such the PMM will not kick in at Adam's ask price. Rather, it will exhaust its current | | | | | | | |
| | inventory for this transaction (which at this point is 9 more shares), , and will stop here on | | | | | | | |
| | this transaction (until other market dynamics make this trade relevant again, e.g. more | | | | | | | |
| | inventory becomes available closer to the $10.75 per share price point). | | | | | | | |
| 8 | Given that the | 90 | 0 | 0 | 0 | 21 | 90 | $10.75 per |
| | current Market | | | | | | | share |
| | price closely | | | | | | | |
| | matches an existing | | | | | | | |
| | Aks price in the | | | | | | | |
| | market (Danielle's), | | | | | | | |
| | the trading engine | | | | | | | |
| | can now proceed to | | | | | | | |
| | sell Danielle's | | | | | | | |
| | shares at her desired | | | | | | | |
| | ask price to Edgar | | | | | | | |
| 9 | The PMM experiences an all stop due to the following reasons: | | | | | | | |
| | Configured Guard Rails for this transaction have been breached, and so they | | | | | | | |
| | will automatically act to prevent run away pricing of the stock | | | | | | | |
| | The PMM allowance (which is a given number of shares that a PMM can | | | | | | | |
| | engage with a given transaction [10% of the original quantities of shares | | | | | | | |
| | ordered]) has been exhausted. | | | | | | | |
| | Totals | 90 (w/ | 0 (w/ | 0 (w/ | 0 (w/ | 21 (w/ | 90 (w/ | $10.75 per |
| | | 100 total | 15 total | 27 total | 7 total | 21 total | 90 total | share |
| | | inv.) | inv.) | inv.) | inv.) | inv.) | inv.) | |

As can be seen from both embodiments, the outcome is the same; however, the key difference between both scenarios is where and how much the PMM participates in the transaction. It is important to note that a primary design element of the MLPS is to help the PMM limit its participation in any market transactions. The core purpose of the PMM is to help move transactions along, not to overstep or takeover a transaction.

Order Limit Guard Rails Logic

Given the way market orders work, there is a real risk of wild price fluctuations in a given market or a given asset for which there isn't a lot of trading volume. What this means is that, in theory, there exists a risk of customers paying substantially much more than they may expect for the execution of a given market order due to a wide bid-ask-spread. The PMM addresses this run-away price effect with built in guard rails that are designed to stop the PMM from triggering on a given trade for which the trade exceeds 10% in total price difference from the start price of the asset when the market order was placed.

It is important to note that this guard rail is a configurable amount the trading engine provides the trader (at their own acknowledgement of underlying risk). The end user can adjust or even turn off the configured guard rail amount all together on a trading transaction by trading transaction basis.

In addition to this price-based guard rail, the PMM has an additional limiter that prevents the PMM's involvement in any given trade if it would result in the PMM transacting more than a pre-configured percentage of shares request of a particular transaction. By way of example, if the configured engine limiter is set to 15% of the number of requested shares in a transaction of 100 shares, then the PMM will not participate in that transaction for more than 15 shares. So, for instance, if it will take more than 15 shares (15% of the 100 share transaction) of buying/selling of the asset in order to close the gap between the market order price and the next bid/ask, the PMM will stop at the 15th share and will wait until another trade comes into play that can itself close the gap. This limiter is based on the trade and not the asset itself. The benefit of this design feature is twofold. First, user trading is prioritized. The PMM's goal is to facilitate trading between end users on the platform and treats that as the priority. Second, PMM inventory is optimized. Since the PMM has a fixed inventory of shares that it uses for its core purpose, this limit is in place to help the PMM optimize how many shares it has on hand to ensure that it can continue to offer maximum market liquidity to as many end users as possible.

While at the surface OLGRs might resemble ATOs (e.g., stop and limit orders), they are fundamentally different in the following ways:

| ATOs | OLGRs |
|---|---|
| Automated Trading Orders, like stop | OLGRs are designed to prevent the |
| orders or limit orders, are designed to | future fulfilment of trades in a |
| halt the purchase (or sale) of a stock | given transaction when the stock |
| when its market price moves past a | market price of the stock |
| specific price point. | associated with that transaction |
| | moves past a specific price point. |
| ATOs are not scoped to (or bound | The scope of any OLGR is scoped |
| by) a single trading transaction. | to a single transaction. As such |
| | different transactions can have |
| | different configured OLGRs |
| ATOs inherently depend on the | OLGRs have no bearing on end |
| inventory of the end user that sets | user inventory. |
| them | |

High Level Data Flows Overview

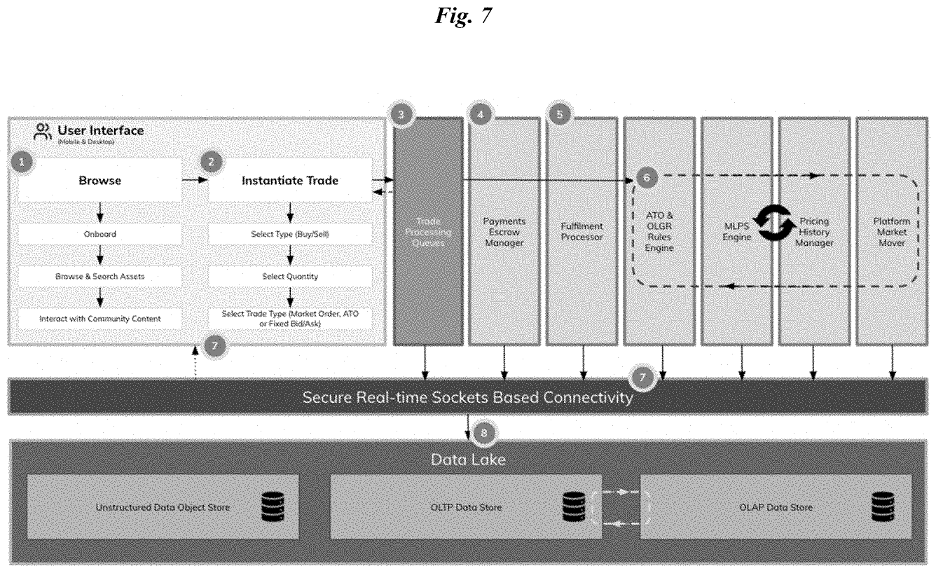

With reference to FIG. 7, the flows, formats, and processing of data into and out of the automated trading platform 100 is shown.

Browsing: At this stage, the end user is browsing our collection of IPOs and secondary trading assets on the platform. Data elements of assets (e.g., updated asset prices, portfolio inventory levels, wallet balances, etc.) on the user interfaces are dynamically updated in real-time by the Secure Real-time Sockets Based Connectivity (SBC) component without the user having to refresh his or her user interface.

Key data capture and processing workflows in this step of the overall data flow include:

1. Onboarding: During the Browse phase in the data flow, the platform may capture data elements of the customer related to assessing KYC (Know your Customer).

2. Browse & Search Assets: During this process, data flows from the OLTP data store about the various assets. This data is further supplemented in real time with updated data from the SBC component, so, for instance, the end user is always appraised with the most updated price of assets on the platform in real-time and without a need to refresh the app.

3. Interact with Community Content: This element of data flows includes the end user creating and reviewing User Generated Content (UGC).

Instantiate Trade: Instantiating a trade on the automated trading platform 100 involves 3 easy steps:

1. Select Asset & Select Type (Buy/Sell): Through the real-time updated user interface, the end user selects an asset they want to trade and elects to buy or sell trades.

2. Select Quantity of Shares: The end user then gets to elect the number of shares they want to trade, and any associated OLGR configuration.

3. Select Trade Type: Finally, the end user selects the type of trade they want to perform. Their options are:

a) Market Order: These types of orders are designed to process the trade at the current market order price of the asset, and the PMM uses the market price of the asset as the starting price of any market movement operations it may perform relative to this current transaction.

b) Raw (Fixed) Bid/Ask: These are similar to market orders, but the end user gets to elect the ask/bid price as opposed to relying on the market price at the time of the transaction.

c) Automated Trading Order (ATO): These types of orders are automated in nature and include orders like stop/limit orders. For more information on ATOS, please see the Automated Trading Orders subsection, in the Supported Trading Order Types section of this document.

Trade Processing Queues: Due to the complexities involved with processing trade orders in a high-velocity trading platform, as well as potential market liquidity challenges (notwithstanding the PMM), all orders created by end users are first persisted in a First In First Out queue (FIFO).

Payments Escrow Manager: The FP of FIGS. 3 and 4 picks up queued orders from each of the FIFO queues, starting first with the buy orders, then the sell orders, and, for each buy order, processes all necessary escrow funds capture, to ensure that the end user executing the purchase has enough funds in their automated trading platform 100 wallet to execute the trades. If there aren't enough funds in the end user's automated trading platform 100 wallet, the transaction is put in a ESCROW FAILED status (for more information about the various transaction statuses supported by the Trading Engine, please see the Platform Enumerations Appendix).

Fulfilment Processor: At this stage the FP proceeds to validate escrow availability, pulls the trade out of the processing queue, and acquires all the data it needs to appropriately source inventory for the order. The next step in the workflow is responsible for using this data as an input to compute how much inventory is available to fulfill the order.

Rule Processing and Trade Execution Workflow: This part of the overall workflow is broken up into four, potentially recurring, steps. As indicated in the above data flow diagram, these steps will continue repeating each other until the trade is completed or the Trading Engine makes a determination that it is unable to complete the trade and therefore puts the transaction in a Pending Status, placing the transaction back at the end of the appropriate trade processing FIFO queue. The four workflow steps can include:

1. Inventory Sourcing via ATO & OLGR Rules Engine: There are four types of inventory sources that are supported by the trading engine. For the purposes of the engine processing shares from any of these inventory sources, they however need to be formatted as an ATO. This step of the workflow takes all inventory sources for a given trading transaction, and converts them into standard ATO format, and validates each inventory source against the configured OLGR rules for the trading transaction. The four types of inventory sources are:

a) Native ATO Inventory: This type of inventory is sourced from existing ATOs placed by other end users on the platform for the stock associated with this trading transaction.

b) Synthetic ATO Inventory: This type of inventory is sourced from raw bid/ask trading transactions. These existing transactions in the system are temporarily converted into ATOs and are given a synthetic delineation so that the engine can process them no differently within the ATO rules engine.

c) PMM Allocation Inventory: This inventory is sourced from available shares that the PMM can operate with, provided the conditions of the PMM involvement are met (e.g., ask/bid spreads create a gap between the market price or the operating price for the transaction and the ask/bid price associated with that transaction). Another condition for the PMM to trigger is there are no OLGR rule violations associated with executing any existing trades computed for the transaction, including any trades resulting from the PMM Allocation inventory.

d) IPO Allocation Inventory: This is a special inventory dedicated to IPO only assets. This type of inventory is generally available until an IPO for a given asset closes or available shares are sold out.

2. Execution of MLPS engine: The MLPS engine is responsible for making predictions of potential bid/ask spreads in the overall inventory of trades that would cause the PMM to intervene. Based on the predictions output by the MLPS, the PMM can adequately spread its allocation for this transaction in a way that optimally provides maximum participation by other traders in this transaction, but also offers the end user for which this trading transaction is being processed the best pricing possible.

3. Persisting Price Changes in Pricing History Manager: If through the execution of any trades by the FP, there is a price change in the stock price, the pricing history manager is automatically triggered to persist this change in price, and after the change has been persisted to the OLTP and OLAP data stores, the price change is sent to the user interface via the SBC component.

4. Execute PMM: The PMM exists to close gaps in ask/bid prices on a given transaction provided certain prerequisites are met:

a) There is an ask/bid spread that creates a gap between the market price (or the operating price for the transaction) and the ask/bid price associated with that transaction.

b) There are no OLGR rule violations associated with executing any existing trades computed for the transaction, including any trades resulting from the PMM Allocation inventory.

Push Real-time Events Throughout the Rest of the System Via the SBC Component: At any point throughout the trading process, if any of the components of the trading engine generate data that can be categorized as a notification event, the SBC is notified to push out that event in real time to any subscribed listeners of the SBC. This includes the data lake and the user interface. A relevant example of this is the price change of an asset as a result of an ATO or the PMM. This event is instantly pushed out to the user interface of every logged-on end user, and they are aware of the updated price of the stock.

Persist Data in Relevant Data Store: Last, any data that is associated with the trade that needs to be persisted in the data store, is processed by this component of the trading engine. Data is persisted in one of three types of data stores depending on the type of data:

1. Unstructured Data Object Store: Our object store is designed to store unstructured data generated by the platform and end users of the platform. This includes data about predictive models, images, Infrastructure as Code (IaC) models (as well as underlying virtual machine images they create), and asset pricing history models, to name a few. Components of the trading engine that interact with the unstructured data object store include: the ATO & OLGR Rules Engine, MLPS Engine, Pricing History Manager, and PMM.

2. OLTP Data Store: Our OLTP data store is designed to store and process transaction-oriented tasks and data. It is optimized to process a large quantity of small amounts of data quickly and efficiently. Components of the trading engine that interact with the OLTP data store include: the Payments Escrow Manager and the Fulfillment Processor.

3. OLAP Data Store: Our OLAP data store powers most of our complex analytics and machine learning modeling use cases as well as all of our Business Intelligence (BI) applications. Components of the trading engine do not interact directly with the OLAP data stores, but rather provide data into the OLTP data stores which are then later processed into the OLAP data stores through big data analytics and our internal data pipeline processes and procedures.

Supported Trading Order Types Market Orders: A market order is a request by an investor—usually made through a broker or brokerage service—to buy or sell a security at the best available price in the current market. It is widely considered the fastest and most reliable way to enter or exit a trade and provides the most likely method of getting in or out of a trade quickly. For many large-cap liquid stocks, market orders fill nearly instantaneously. As previously described, market orders can be configured to have OLGRs, which are upper and lower limits configured on every market order and designed to stop the fulfillment of the market order automatically if the price of the stock goes above (in the case of a buy order) or below (in the case of a sell order) a given configured guard rail percentage. By default, the OLGR is configured to be 10% of the market price at the time when the order was created. This security feature is meant to prevent the run-away effect of the price of the order in scenarios where the asset has low trading volumes and therefore potentially high bid/ask spreads.

Market orders on the automated trading platform 100 are designed to be the quickest type of orders that are executed by the system, because they are designed to continue attempting to fulfil the order at the current market price of a given security (with consideration given to the order limit guardrails configured by the end user).

Raw Asks & Bids Orders: In contrast, raw asks and bids orders are meant to be exacting orders which only execute when the ask price of the seller matches (or is better than) the bid price of the buyer. These types of orders are stricter and offer more fine-grained control to the investor, as well as much more granular predictability in the price of the executed trade. Due to the advanced sophistication of these types of bids and the increased finer grained control the investor has over the trade, these types of orders are a premium feature in the automated trading platform 100.

ATOs: These types of orders are configured by the end user and are designed to execute only under certain conditions. There are several types of ATOs that are supported by the automated trading platform 100 including but not limited to:

1. Stop Order: A stop order is an order placed in the automated trading platform 100 to buy or sell a specific stock once the stock reaches a certain price. A stop-loss is designed to limit an investor's loss on a security position. For example, setting a stop-loss order for 10% below the price at which you bought the stock will limit your loss to 10%, and cause the platform to automatically trigger a market order to sell the end user's holdings of the stock.

2. Limit Order: A limit order is an order placed in the platform to buy a specific stock at a certain price limit or lower.

3. Kill or Fill Order: Kill or fill orders are designed to be fulfilled in its entirety or the order doesn't go through.

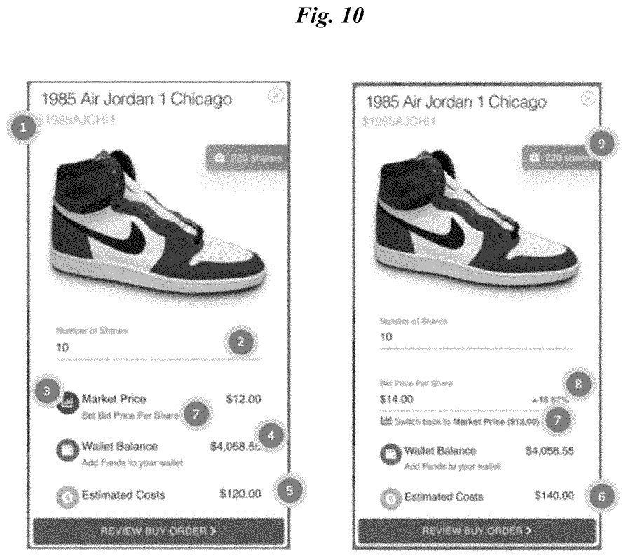

FIG. 10 illustrates an exemplary user interface that is presented to the end user during the order placement process. The design of this UI is meant to offer transparency to the end user without sacrificing configurability and simplicity in the ordering process. Each bullet point is referenced in the numbered list proceeding the table.

(1) The Stock Symbol

(2) The Quantity of Shares being purchased

(3) The Market Price Indicator

(4) The End User's current wallet balance

(5) The Estimated Costs of the purchase at Market Price

(6) The Estimated Costs of the purchase at Bid Price

(7) Toggle Switches to switch between Market Price and a user specified Ask/Bid Price

(8) Percentage indicator of difference between current Market Price and user specified Bid Price

(9) Total number of shares the user already owns of this Symbol in their portfolio

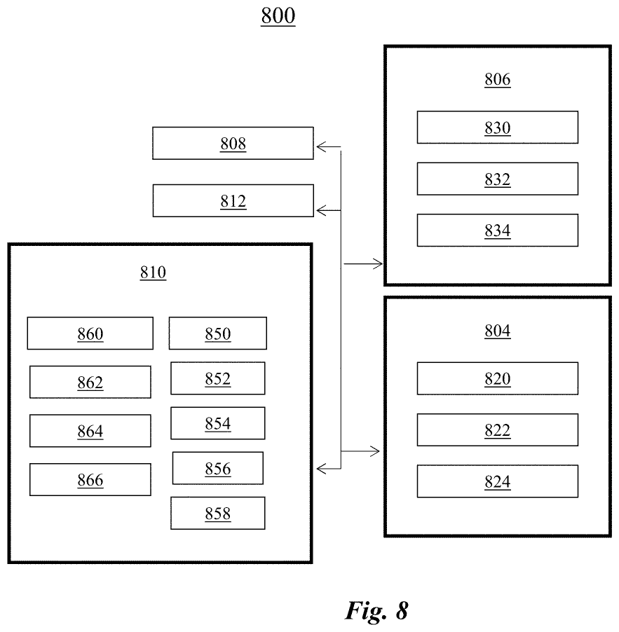

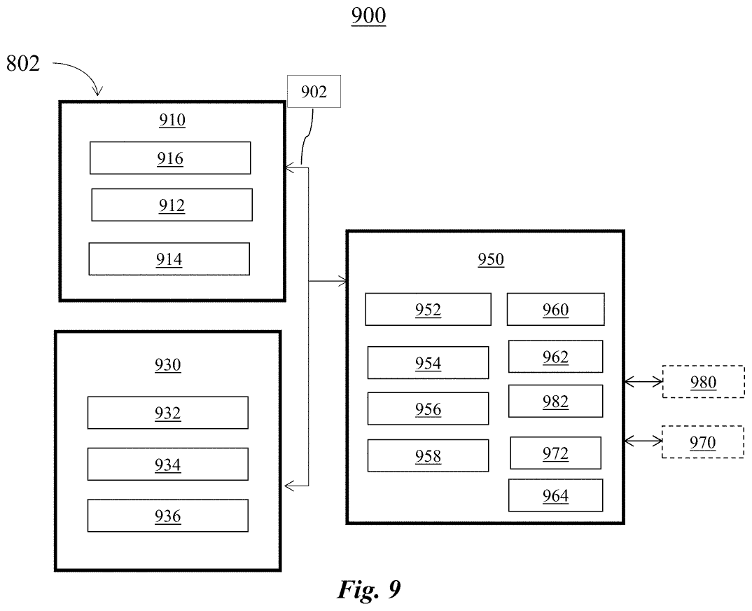

FIG. 8 is a block diagram illustrating a software architecture 800, which can be installed on any one or more of the devices described herein. FIG. 8 is merely a non-limiting example of a software architecture, and it will be appreciated that many other architectures can be implemented to facilitate the functionality described herein. In various embodiments, the software architecture 800 is implemented by hardware such as a machine 900 of FIG. 9.

In this example architecture, the software architecture 800 can be conceptualized as a stack of layers where each layer may provide a particular functionality. For example, the software architecture 800 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various graphical user interface (GUI) functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the methods of FIG. 5 or 6. Additionally, or alternatively, the instructions 916 may implement any of the features described with reference to FIG. 6. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions 916 contemporaneously. Although FIG. 9 shows multiple processors 910, the machine 900 may include a single processor 912 with a single core, a single processor 912 with multiple cores (e.g., a multi-core processor 912), multiple processors 912, 914 with a single core, multiple processors 912, 914 with multiple cores, or any combination thereof.

The memory 930 may include a main memory 932, a static memory 934, and a storage unit 936, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., coupled via a USB).

Moreover, the communication components 964 may detect identifiers or include components operable to detect identifiers. For example, the communication components 964 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

The various memories (i.e., 930, 932, 934, and/or memory of the processor(s) 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” can be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Embodiments of this solution may be implemented in one or a combination of hardware, firmware and software. Embodiments may also be implemented as instructions stored on a computer-readable storage device, which may be read and executed by at least one processor to perform the operations described herein. A computer-readable storage device may include any non-storing information in a form readable by a machine (e.g., a computer). For example, a computer-readable storage device may include read-only memory (ROM), random-access memory (RAM), magnetic disk storage media, optical storage media, flash-memory devices, cloud servers or other storage devices and media. Some embodiments may include one or more processors and may be configured with instructions stored on a computer-readable storage device. The following description and the referenced drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The above description includes references to the accompanying drawings, which form a part of the detailed description. The drawings show, by way of illustration, specific embodiments in which the systems and methods disclosed herein can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A system for automated trading, comprising:
one or more data stores;
a user interface in operable connection with the one or more data stores; and
a trading engine in operable communication with the user interface and the one or more data stores, wherein the trading engine comprises:
a machine learning predictive simulation engine for predicting points within a trading transaction by generating a predictive model; and
a platform market mover to automatically execute the trading transaction by identifying gaps in inventory or bid-ask pricing based on the generated predictive model.

2. The system of claim 1, further comprising a fulfillment processor to compute effective inventory and a number of trades needed to fulfil the trading transaction sent to the trading engine.

3. The system of claim 1, wherein the machine learning predictive simulation engine predicts points within the trading transaction by implementing a pattern matching algorithm based on a set of one or more rules of the one or more data stores.

4. The system of claim 3, wherein the pattern matching algorithm comprises the Rete algorithm.

5. The system of claim 1, wherein said platform market mover defines an upper limit and a lower limit of the trading transaction that automatically stops the automatic execution of the trading transaction if a change in a price of a given stock that results from the automatic execution of the trading transaction falls outside the upper and lower limits.

6. The system of claim 5, wherein said user interface automatically provides real-time information of the change in the price of the given stock resulting from the automated execution of the trading transactions.

7. The system of claim 1, wherein said one or more data stores maintains data for the platform market mover to execute the trading transaction and historical data for the machine learning predictive simulation engine to generate the predictive model.

8. The system of claim 7, wherein said one or more data stores comprises at least one unstructured data object store, at least one online transactional processing data store, and at least one online analytical processing data store, and wherein the historical data and the generated predictive models are persisted in the at least one unstructured data object store.

9. A computer-implemented method of automated trading, comprising:
receiving, via a user interface, a user-selected trading transaction;
generating a predictive model via a machine learning predictive simulation engine, the generated predictive model for predicting points within the user-selected trading transaction; and
automatically executing the user-selected trading transaction by identifying gaps in inventory or bid-ask pricing based on the generated predictive model via a platform market mover in operable communication with the user interface.

10. The computer-implemented method of claim 9, further comprising computing, via a fulfillment processor, effective inventory and a number of trades needed to fulfil the trading transaction sent to the platform market mover.

11. The computer-implemented method of claim 9, wherein said generating a predictive model comprises predicting points within the user-selected trading transaction by implementing a pattern matching algorithm based on a set of one or more rules.

12. The computer-implemented method of claim 11, wherein the pattern matching algorithm comprises the Rete algorithm.

13. The computer-implemented method of claim 9, wherein said platform market mover defines an upper limit and a lower limit of the user-selected trading transaction and said automatically executing the user-selected trading transaction is automatically stopped if a change in a price of a given stock that results from the automatic execution of the trading transaction falls outside the upper and lower limits.

14. The computer-implemented method of claim 13, further comprising automatically providing, via the user interface, real-time information of the change in the price of the given stock resulting from the automated execution of the trading transactions.

15. The computer-implemented method of claim 9, further comprising automatically stopping the execution of the automated trading transaction based on the generated predictive model to preserve the trading transaction for later execution.

16. A non-transitory nonvolatile computer program product comprising a processor-readable medium having a sequence of instructions stored thereon, which, when executed by the processor, causes the processor to execute a method of automated trading, the sequence of instructions comprising:
instructions for receiving, via a user interface, a user-selected trading transaction;
instructions for generating a predictive model via a machine learning predictive simulation engine, the generated predictive model for predicting points within the user-selected trading transaction; and
instructions for automatically executing the user-selected trading transaction by identifying gaps in inventory or bid-ask pricing based on the generated predictive model via a platform market mover in operable communication with the user interface.

17. The computer program product of claim 16, further comprising instructions for computing, via a fulfillment processor, effective inventory and a number of trades needed to fulfil the trading transaction sent to the platform market mover.

18. The computer program product of claim 16, wherein said instructions for generating the predictive model comprises instructions for predicting points within the user-selected trading transaction by implementing a pattern matching algorithm based on a set of one or more rules.

19. The computer program product of claim 18, wherein the pattern matching algorithm comprises the Rete algorithm.

20. The computer program product of claim 16, wherein said platform market mover defines an upper limit and a lower limit of the user-selected trading transaction and said automatically executing the user-selected trading transaction is automatically stopped if a change in a price of a given stock that results from the automatic execution of the trading transaction falls outside the upper and lower limits.
